(19) United States
(12) Patent Application Publication
(10) Pub. No.: US 2011/0020774 A1
(43) Pub. Date: Jan. 27, 2011

(54) SYSTEMS AND METHODS FOR FACILITATING FOREIGN LANGUAGE INSTRUCTION

(75) Inventor: Phuc H. Nguyen, Highlands Ranch, CO (US)

Correspondence Address: SEED INTELLECTUAL PROPERTY LAW GROUP PLLC, 701 FIFTH AVENUE, SUITE 5400, SEATTLE, WA, 98104, US

(73) Assignee: ECHOSTAR TECHNOLOGIES L.L.C., Englewood, CO (US)

(21) Appl. No.: 12/509,374

(22) Filed: Jul. 24, 2009

(51) Int. Cl. G09B 19/06; H04N 7/173

(52) U.S. Cl. 434/157; 725/131

(57) ABSTRACT

Various embodiments facilitate foreign language instruction. In one embodiment, a foreign language tutor is provided for execution on a receiving device, such as a set-top box. The foreign language tutor facilitates language instruction by enabling a user to view a received program in various languages, even though those languages may not be part of the audio or subtitles of the received program. In particular, the user may view the received program with an audio track in his/her native language and a subtitle track in a foreign language, or vice versa. In addition, the foreign language tutor is configured to obtain and display reference information (e.g., a dictionary definition) for a word of a subtitle track. This abstract is provided to comply with rules requiring an abstract, and it is submitted with the intention that it will not be used to interpret or limit the scope or meaning of the claims.

### TECHNICAL FIELD

The technical field relates to facilitating foreign language instruction and more particularly, to apparatus, systems, and methods for using a receiving device, such as a set-top box, to teach a viewer a foreign language.

### BRIEF SUMMARY

In one embodiment, a set-top box facilitates foreign language instruction. The set-top box includes an audio/video processor that is configured to receive program data from a satellite network, the program comprising video content, at least one audio track in a corresponding language, and a plurality of subtitle tracks that are each in a corresponding language. The set-top box further includes a language tutor module that is configured to: receive from a user an indication of a first language and a second language, wherein the first language is different than the languages corresponding to the at least one audio track or the second language is different than the languages corresponding to the plurality of subtitle tracks; obtain an audio track in the first language and a subtitle track in the second language; transmit to the user the video content, the obtained audio track in the first language, and the obtained subtitle track in the second language; receive from the user an indication of a word in the obtained subtitle track; and in response to the received indication of the word, transmit reference information about the indicated word.

In another embodiment, a method in a receiving device for facilitating foreign language instruction is provided. The method includes: receiving program data that includes video content, at least one audio track in a corresponding language, and at least one subtitle track in a corresponding language; receiving an indication of a first language and a second language, wherein the first language is different than the languages corresponding to the at least one audio track or the second language is different than the languages corresponding to the at least one subtitle track; obtaining an audio track in the first language and a subtitle track in the second language, one of the audio track and the subtitle track obtained from a source other than the program data; and transmitting the video content, the obtained audio track, and the obtained subtitle track.

In a further embodiment, a computer-readable storage medium includes contents that perform a method for facilitating foreign language instruction. The method includes: receiving program data that includes video content and at least one audio track in a corresponding language; obtaining an audio track and a subtitle track; presenting the video content, the obtained audio track, and the obtained subtitle track; and during presentation of the video content, receiving an indication of a word in the obtained subtitle track; obtaining reference information about the indicated word; and presenting the obtained reference information.

### BRIEF DESCRIPTION OF THE DRAWINGS

The components in the drawings are not necessarily to scale relative to each other. Like reference numerals designate corresponding parts throughout the several views.

FIG. 1A is a block diagram illustrating functional elements of an example embodiment of a foreign language tutor.

FIG. 1B is a block diagram illustrating an example content distribution environment in which embodiments of a foreign language tutor may be implemented.

FIGS. 2A-2D are block diagrams illustrating example user interfaces provided by example embodiments.

FIG. 3 is a block diagram of a computing system for practicing example embodiments of a foreign language tutor.

FIG. 4 is a flow diagram of an example foreign language tutor process provided by a first example embodiment.

FIG. 5 is a flow diagram of an example foreign language tutor process provided by a second example embodiment.

### DETAILED DESCRIPTION

A. Environment Overview

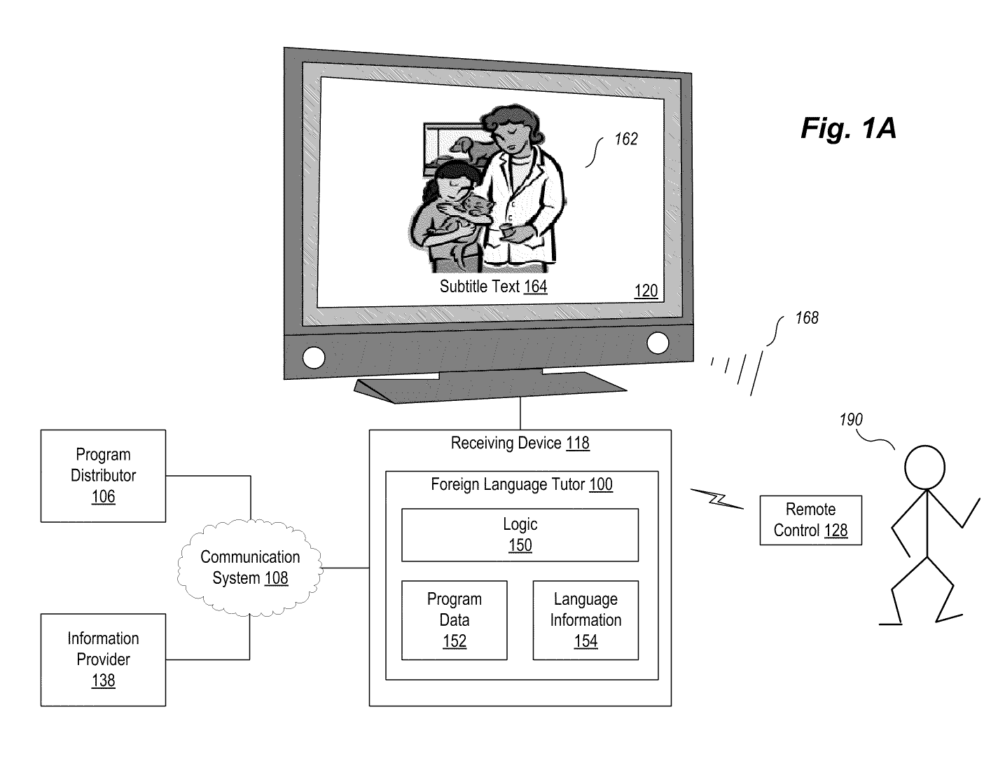

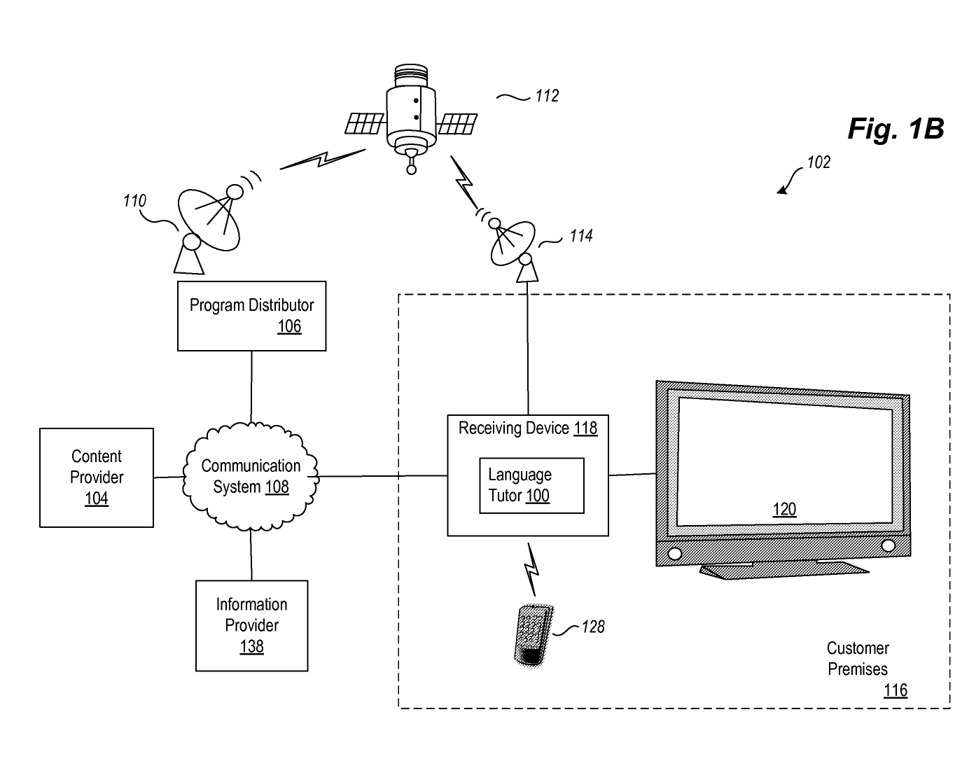

FIG. 1A is a block diagram illustrating functional elements of an example embodiment of a foreign language tutor 100. The foreign language tutor 100 facilitates the acquisition of a foreign language by a user 190 by presenting programming, such as a film, upon a presentation device 120. In one configuration, the user 190 can direct the foreign language tutor 100 to play the program audio in his/her native language, while presenting subtitles in a foreign language they desire to learn. In another configuration, the user 190 can direct the foreign language tutor 100 to play the program audio in a foreign language, while presenting subtitles in his/her native language. In addition, the user 190 can direct the foreign language tutor 100 to display reference information, such as a dictionary definition, about a word or phrase of a subtitle.

The illustrated foreign language tutor 100 operates upon a receiving device 118, such as a set-top box. The foreign language tutor 100 includes logic 150, program data 152, and language information 154. The receiving device 118 is communicatively coupled to a presentation device 120, and to a program distributor 106 and an information provider 138 via a communication system 108. The user 190 interacts with the receiving device and/or the presentation device 120 by using a remote-control device 128.

The receiving device 118 receives from the program distributor 106 an audio/video program, such as a film or a television program, and stores the received program as program data 152. The program data typically includes video content, at least one audio track, and multiple subtitle tracks. The audio tracks and subtitle tracks are each in a corresponding language. For example, a particular program may have audio tracks in English and Spanish, and subtitle tracks in English, Spanish, and French. The receiving device 118 presents the video content, one of the audio tracks, and one of the subtitle tracks upon the presentation device 120 as images 162, subtitle text 164, and audio output 168, respectively.

The foreign language tutor 100 receives an indication from the user 190 of a first and second language. The foreign language tutor 100 then obtains an audio track in the first language and a subtitle track in the second language. Typically, one of the two indicated languages is a language native to the user 190, and the other of the two indicated languages is a language that is not native to the user 190. For example, the user 190 may be attempting to improve his/her foreign language reading skills, and will indicate his/her native language as the first language (for the audio track) and indicate the foreign language as the second language (for the subtitle track). In that way, the user 190 can read foreign language subtitle text 164 while hearing native language audio output 168. Alternatively, the user 190 may be attempting to improve his/her spoken language skills, and will indicate the foreign language as the first language (for the audio track) and indicate his/her native language as the second language (for the subtitle track). In that way, the user 190 can read native language subtitle text 164 while hearing foreign language audio output 168.

Obtaining an audio track and a subtitle track can be performed in various ways. In some cases, one or both of the audio and subtitle tracks are part of the program data 152, as received from the program distributor 106. In other cases, at least one of the audio or subtitle tracks are not part of the received program data 152. In such circumstances, the foreign language tutor 100 automatically obtains the appropriate track from another source, such as remotely from the information provider 138 and/or locally from the language information 154. The information provider 138 and/or language information 154 may include a library or other type of data repository of audio or subtitle tracks for one or more programs. In some cases, the information provider 138 may be operated by a third party to the operator of the program distributor 106. In some embodiments, audio or subtitle tracks are available from an information source, such as information provider 138, in exchange for a fee. In other embodiments, the foreign language tutor 100 performs machine translation of one of the tracks that are part of the received program data to generate a track in the user-specified language.

In addition, the foreign language tutor 100 is configured to display reference information about subtitle text 164. For example, in response to a request received from the user 190, such as a selection of a word or phrase of the subtitle text 164, the foreign language tutor 100 obtains reference information about the selected word, and displays the obtained reference information on the presentation device 120. Reference information may be obtained locally from the language information 156 or remotely from the information provider 138. Reference information includes dictionary definitions, translations, thesaurus entries, and the like.

FIG. 1B is a block diagram illustrating an example content distribution environment 102 in which embodiments of a foreign language tutor 100 may be implemented. In the content distribution environment 102, audio, video, and/or data service providers, such as, but not limited to, television service providers, provide their customers audio/video/data programming (hereafter, collectively and/or exclusively “programming”). Such programming is often provided by use of the receiving device 118 communicatively coupled to the presentation device 120 configured to receive the programming. As noted above, the foreign language tutor 100 operates upon the receiving device 118.

The receiving device 118 interconnects to one or more communications media or sources (such as a cable head-end, satellite antenna, telephone company switch, Ethernet portal, off-air antenna, or the like) that provide the programming. The receiving device 118 commonly receives programming by way of the communications media or sources described in greater detail below. Based upon selection by a user, the receiving device 118 processes and communicates the selected programming to the presentation device 120.

For convenience, the receiving device 118 may be interchangeably referred to as a “television converter,” “receiver,” “set-top box,” “television receiving device,” “television receiver,” “television recording device,” “satellite set-top box,” “satellite receiver,” “cable set-top box,” “cable receiver,” “media player,” and/or “television tuner.” Accordingly, the receiving device 118 may be any suitable converter device or electronic equipment that is operable to receive programming. Further, the receiving device 118 may itself include user interface devices, such as buttons or switches. In many applications, the remote-control device (“remote”) 128 is operable to control the receiving device 118 and/or the presentation device 120. The remote 128 typically communicates with the receiving device 118 using a suitable wireless medium, such as infrared (“IR”), radio frequency (“RF”), or the like.

Examples of the presentation device 120 include, but are not limited to, a television (“TV”), a personal computer (“PC”), a sound system receiver, a digital video recorder (“DVR”), a compact disk (“CD”) device, game system, or the like. Presentation devices 120 employ a display, one or more speakers, and/or other output devices to communicate video and/or audio content to a user. In many implementations, one or more presentation devices 120 reside in or near a customer's premises 116 and are communicatively coupled to the receiving device 118. Further, the receiving device 118 and the presentation device 120 may be integrated into a single device. Such a single device may have the above-described functionality of the receiving device 118 and the presentation device 120, or may even have additional functionality.

A content provider 104 provides program content, such as television content or audio content, to a distributor, such as the program distributor 106. Example content providers include television stations which provide local or national television programming, special content providers which provide premium based programming or pay-per-view programming, or radio stations which provide audio programming.

Program content, interchangeably referred to as a program, is communicated to the program distributor 106 from the content provider 104 through suitable communication media, generally illustrated as communication system 108 for convenience. Communication system 108 may include many different types of communication media, now known or later developed. Non-limiting media examples include telephony systems, the Internet, internets, intranets, cable systems, fiber optic systems, microwave systems, asynchronous transfer mode (“ATM”) systems, frame relay systems, digital subscriber line (“DSL”) systems, radio frequency (“RF”) systems, and satellite systems.

In at least one embodiment, the received program content is converted by the program distributor 106 into a suitable signal (a “program signal”) that is communicated (i.e., “uplinked”) by antenna 110 to satellite 112 (separately illustrated herein from, although considered part of, the communication system 108). The communicated uplink signal may contain a plurality of multiplexed (e.g., time division multiplexed) programs that are organized into distinct logical or physical channels. The uplink signal is received by the satellite 112 and then communicated (i.e., “downlinked”) from the satellite 112 in one or more directions, for example, onto a predefined portion of the planet.

A receiver antenna 114 that is within reception range of the downlink signal communicated from satellite 112 receives the above-described downlink signal. Some types of receiver antenna 114 are operable to receive signals from a single satellite 112. Other types of receiver antenna 114 are operable to receive signals from multiple satellites 112 and/or from terrestrial based transmitters. In some embodiments, antenna 114 is a terrestrial “over-the-air” (“OTA”) broadcast antenna that is configured to receive a program signal from a terrestrial based transmitter, such as broadcast transmit tower. Furthermore, in some cases, the receiving device 118 is operable to receive signals from multiple, distinct antennas.

The receiver antenna 114 can be located at customer premises 116. Examples of customer premises 116 include a residence, a business, or any other suitable location operable to receive signals from satellite 112. The received signal is communicated, typically over a hard-wire connection, to a receiving device 118. The receiving device 118 converts, via an audio/video processor or similar component, the received signal from antenna 114 into a signal and/or format suitable for communication to a presentation device 120 or another device, such as a digital video recorder or a home computing system. In some embodiments, the receiver antenna 114 may be remotely located from the customer premises 116. For example, the antenna 114 may be located on the roof of an apartment building, such that the received signals may be transmitted, after possible recoding, via cable or other mechanisms, such as Wi-Fi, to the customer premises 116.

The receiving device 118 may receive programming partially from, or entirely from, another source other than the above-described receiver antenna 114. Other embodiments of the receiving device 118 may receive data from program distributors 106 and/or content providers 104 via locally broadcast RF signals, cable, fiber optic, Internet media, or the like.

In addition, information provider 138 may provide various forms of content and/or services to various devices residing in the customer premises 116. For example, information provider 138 may provide a Web page (or other information) to the receiving device 118 or other computing device. Information provider 138 may further perform or facilitate electronic commerce transactions.

The above description of the content distribution environment 102 and the customer premises 116, and the various devices therein, is intended as a broad, non-limiting overview of an example environment in which various embodiments of a foreign language tutor may be implemented. FIG. 1B illustrates just one example of a content distribution environment 102 and that the various embodiments discussed herein are not limited to such environments. In particular, content distribution environment 102 and the various devices therein, may contain other devices, systems and/or media not specifically described herein.

Example embodiments described herein provide applications, tools, data structures and other support to implement a foreign language tutor that facilitates foreign language instruction. Other embodiments of the described techniques may be used for other purposes or contexts, such as for viewing Web pages or other content in order to learn a foreign language. In the following description, numerous specific details are set forth, such as data formats, code sequences, and the like, in order to provide a thorough understanding of the described techniques. The embodiments described also can be practiced without some of the specific details described herein, or with other specific details, such as changes with respect to the ordering of the code flow, different code flows, and the like. Thus, the scope of the techniques and/or functions described are not limited by the particular order, selection, or decomposition of steps described with reference to any particular module, component, or routine.

B. Example Foreign Language Tutor User Interfaces

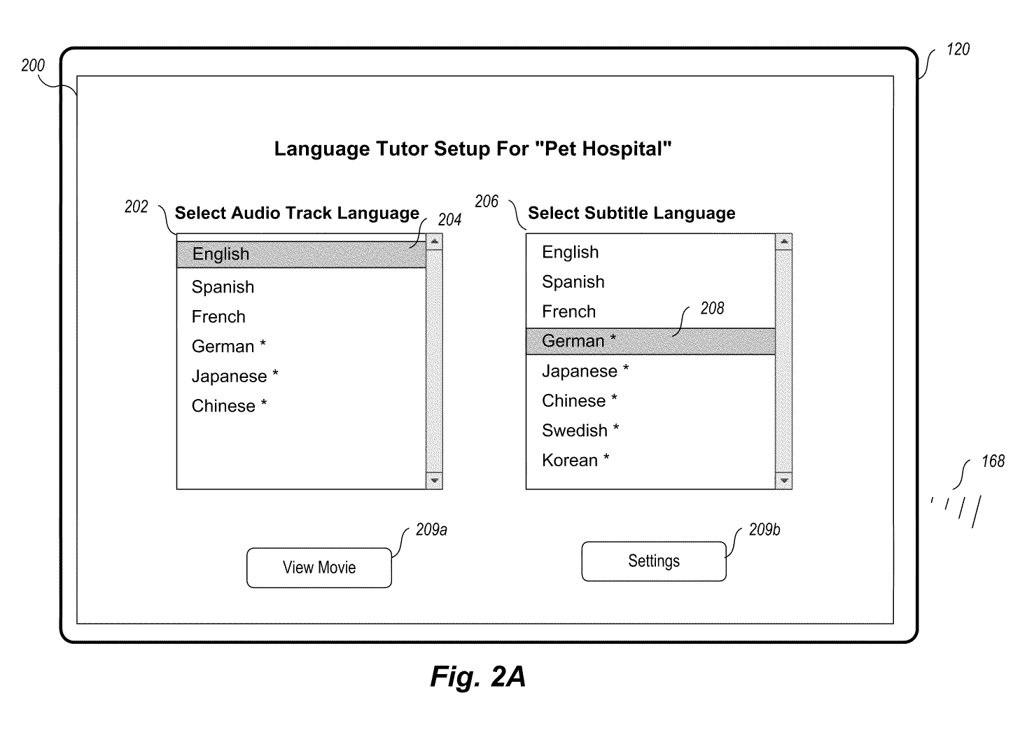

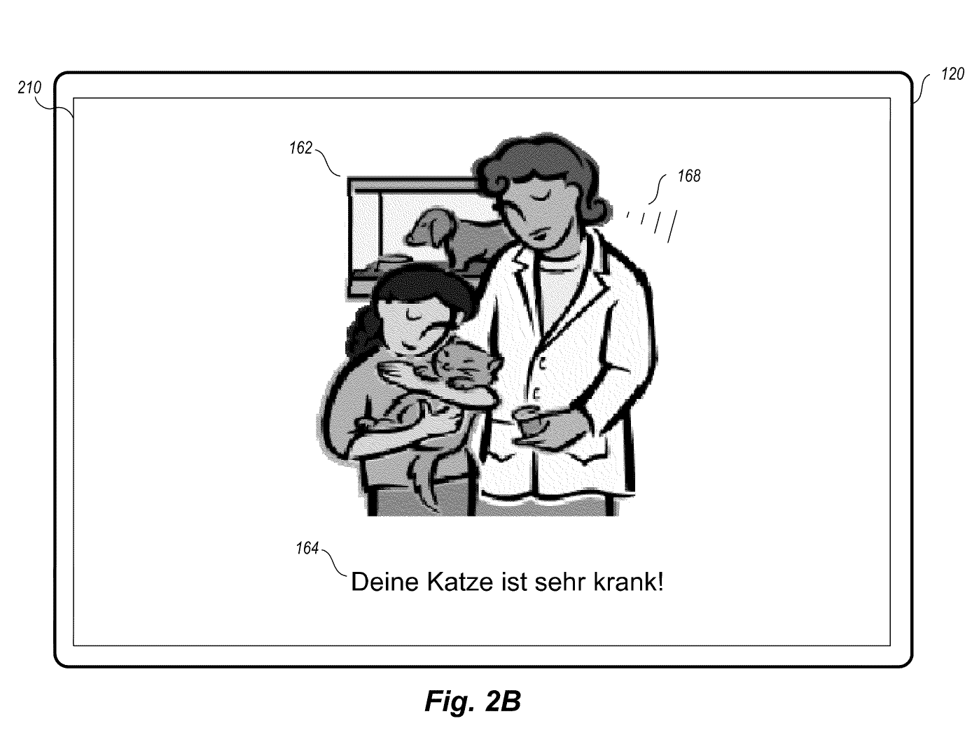

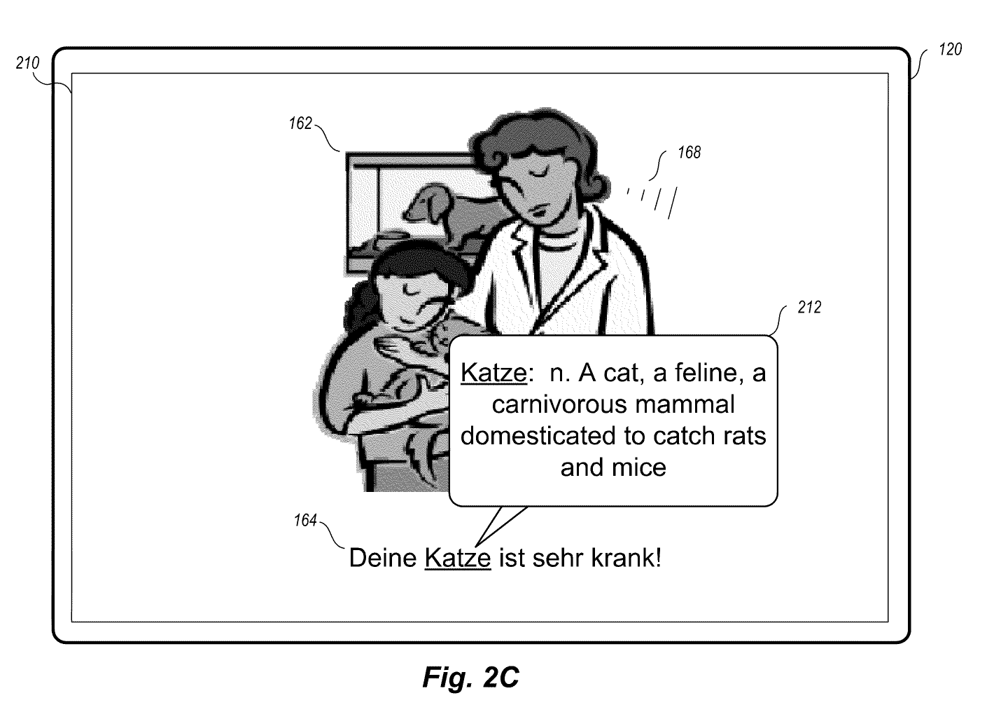

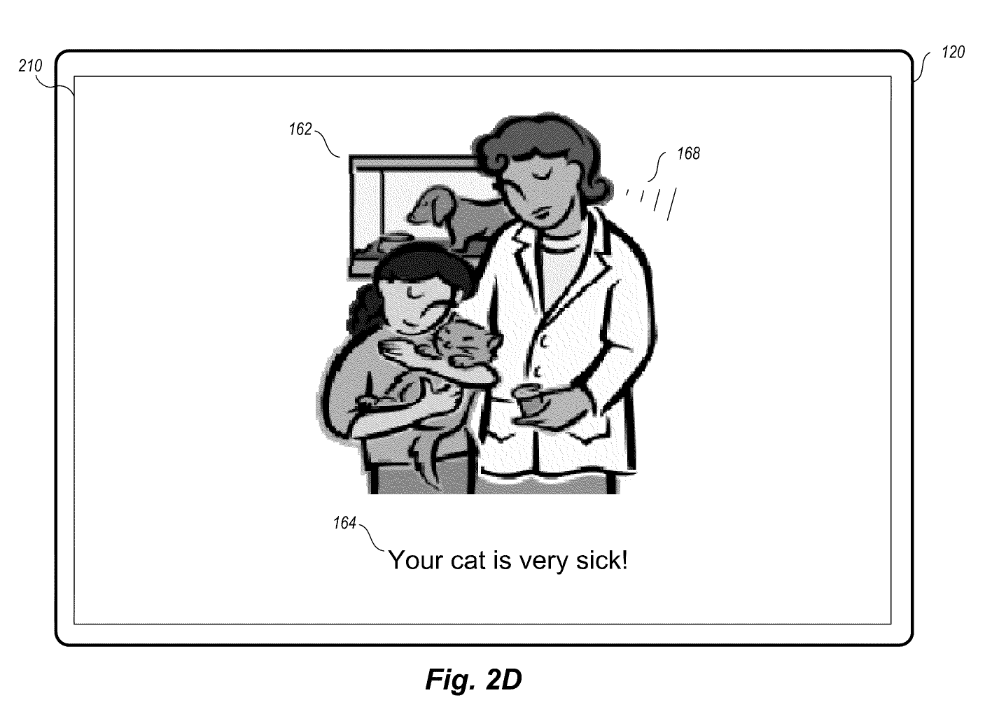

FIGS. 2A-2D are block diagrams illustrating example user interfaces provided by example embodiments. In particular, FIG. 2A shows a user interface screen 200 displayed by the foreign language tutor 100 upon a presentation device 120. The screen 200 is a configuration screen that allows a user to specify the audio track language and subtitle track language prior to (or during) viewing of a particular program. In this example, the user is selecting languages prior to viewing a program entitled “Pet Hospital.”

The screen includes menus 202 and 206. The menu 202 includes indications of multiple available audio track languages. In this example, the menu 202 identifies audio tracks in English, Spanish, French, German, Japanese, and Chinese. The user positions indicator 204 to specify (highlight) an audio track that is to be played for a particular program. In this example, the user has selected English, which is the user's native language. The menu 206 includes indications of multiple available subtitle track languages. In this example, the menu 206 identifies subtitle tracks in English, Spanish, French, German, Japanese, Chinese, Swedish, and Korean. The user positions indicator 208 to specify (highlight) a subtitle track that is to be presented for a particular program. In this example, the user has selected German, which is a language that is foreign to the user.

Some of the languages displayed in menu 202 and 206 include an asterisk (“*”), which indicates that the language is not available as part of the received program, but is available from another, possibly remote source. In the illustrated embodiment, if a language is listed in a menu without an indicator (e.g., English, Spanish, and French in menu 202), then that language is included as part of the program data received by the foreign language tutor 100. On the other hand, if a listed language is associated with an asterisk (e.g., German, Japanese, and Chinese in menu 202), then that language is not part of the program data received by the foreign language tutor 100, but is available from some other source. In this manner, the user can be notified that some languages are available from another, possibly third-party source. Other types of indicators are contemplated. In one embodiment, a currency symbol (e.g., a dollar sign) is used to indicate when a particular language is available for a fee. In another embodiment, a grade or rating is associated with a particular language to reflect the quality of the corresponding audio or subtitle track.

The screen 200 also includes user-selectable controls 209a and 209b. Controls 209a and 209b are buttons that can be activated by the user in order to initiate presentation of the program and to configure the operation/behavior of the foreign language tutor 100, respectively. Configuring the behavior of the foreign language tutor 100 includes selecting default languages for audio and subtitle tracks, identifying preferred reference information sources, specifying default payment information (e.g., to purchase audio/subtitle tracks), and the like.

FIG. 2B shows a user interface screen 210 displayed upon the presentation device 120. The screen 210 includes a video image 162 and subtitle text 164. The presentation device 120 is also producing audio output 168. In this example, the receiving device 118 is presenting the program entitled “Pet Hospital,” with an audio track in English and a subtitle track in German, as specified in the example of FIG. 2A, above. In particular, the audio output 168 includes an English utterance of “Your cat is very sick!” from a character shown in the video image 162. The audio output 168 is shown translated in the German subtitle text 164 as “Deine Katze ist sehr krank!” By listening to the English audio output 168 whilst reading the German subtitle text 164, the English-speaking user can improve his/her German reading comprehension skills.

FIG. 2C shows a user interface screen 210 displayed upon the presentation device 120. The screen 210 includes a video image 162 and subtitle text 164. The presentation device 120 is also producing audio output 168. This example is similar to the one described with respect to FIG. 2B, except that here the user has requested reference information about one of the words (“Katze”) in the subtitle text 164.

In a typical embodiment, the user can use a remote-control device to pause the program, indicate one of the words of the subtitle text 164, and request reference information about the indicated word. In response, the foreign language tutor 100 obtains reference information, such as a translation, dictionary definition, thesaurus entry, etymology, or the like. Then, the foreign language tutor 100 displays the obtained reference information as reference information bubble 212. Reference information bubble 212 provides a translation of the German word “Katze” as corresponding to the English word “cat,” along with a corresponding dictionary definition in English.

The reference information may be obtained from various sources, including those local or remote to the receiving device 118. For example, reference information may be obtained from (local) language information 154 or from (remote) information provider 138, described with reference to FIG. 1A.

FIG. 2D shows a user interface screen 210 displayed upon the presentation device 120. The screen 210 includes a video image 162 and subtitle text 164. The presentation device 120 is also producing audio output 168. In this example, the receiving device is also presenting the program entitled “Pet Hospital,” but with an audio track in German and a subtitle track in English. In particular, the audio output 168 includes a German utterance of “Deine Katze ist sehr krank!” from a character shown in the video image 162. The audio output 168 is shown translated in the English subtitle text 164 as “Your cat is very sick!” By listening to the German audio output 168 whilst reading the English subtitle text 164, the English-speaking user can improve his/her German listening comprehension skills.

Other features are contemplated. In one embodiment, multiple subtitle tracks (e.g., in English and German) may be simultaneously displayed, such that the user can obtain a running textual translation of a foreign language subtitle track. In another embodiment, the user can utilize any “trick mode” features, such as fast forward, pause, reverse, and the like in conjunction with the foreign language tutor 100, in order to learn at a comfortable pace. In another embodiment, reference information may include audio information, such as a pronunciation guide for foreign language words.

C. Example Computing System Implementation

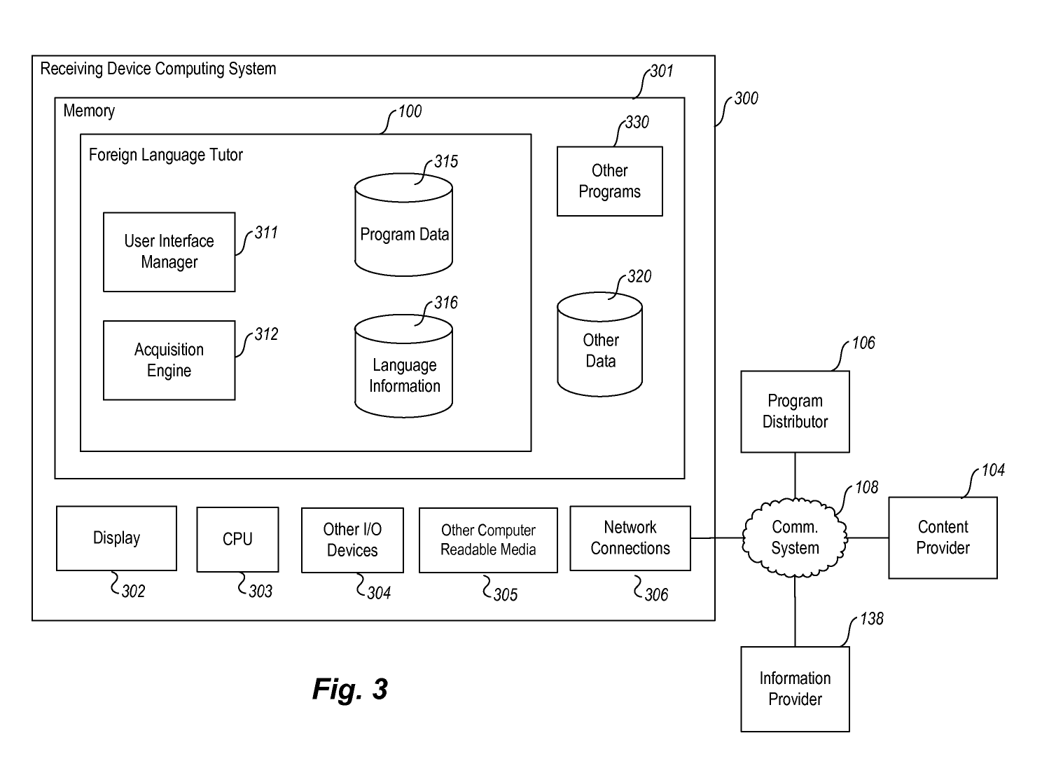

FIG. 3 is a block diagram of a computing system for practicing example embodiments of a foreign language tutor. FIG. 3 shows a receiving device computing system 300 that may be utilized to implement a foreign language tutor 100. In one embodiment, the receiving device computing system 300 is part of a set-top box configured to receive and display programming on a presentation device. In other embodiments, the receiving device computing system 300 is part of a presentation device, such as a television.

Note that one or more general purpose or special purpose computing systems/devices may be used to implement the foreign language tutor 100. In addition, the computing system 300 may comprise one or more distinct computing systems/devices and may span distributed locations. Furthermore, each block shown may represent one or more such blocks as appropriate to a specific embodiment or may be combined with other blocks. Also, the foreign language tutor 100 may be implemented in software, hardware, firmware, or in some combination to achieve the capabilities described herein.

In the embodiment shown, receiving device computing system 300 comprises a computer memory (“memory”) 301, a display 302, one or more Central Processing Units (“CPU”) 303, Input/Output devices 304 (e.g., audio processor, video processor, keyboard, mouse, CRT or LCD display, and the like), other computer-readable media 305, and network connections 306. The foreign language tutor 100 is shown residing in memory 301. In other embodiments, some portion of the contents, some of, or all of the components of the foreign language tutor 100 may be stored on and/or transmitted over the other computer-readable media 305. The components of the foreign language tutor 100 preferably execute on one or more CPUs 303 and facilitate the re-recording of disrupted programming, as described herein. Other code or programs 330 (e.g., an audio/video processing module, a program guide manager module, a Web server, and the like) and potentially other data repositories, such as data repository 320, also reside in the memory 301, and preferably execute on one or more CPUs 303. Of note, one or more of the components in FIG. 3 may not be present in any specific implementation. For example, some embodiments may not provide other computer readable media 305 or a display 302.

In a typical embodiment, the foreign language tutor 100 includes a user interface manager 311, an acquisition engine 312, a data repository 315 that includes program data, and a data repository 316 that includes language information. The foreign language tutor 100 interacts via the communication system 108 with program distributor 106, content provider 104, and/or information provider 138, as discussed with respect to FIGS. 1A-1B.

The user interface manager 311 provides a view and a controller that facilitate user interaction with the foreign language tutor 100 and its various components. For example, the user interface manager 311 provides interactive graphical user interface screens such as those described with respect to FIGS. 2A-2D. As discussed, such user interfaces allow the user to specify an audio track language and a subtitle track language for a particular program. Such user interfaces also allow the user to interact with a program and its subtitle text in order to obtain reference information or perform other functions that facilitate language instruction. The user interface manager 311 also receives input from a user (e.g., in the form of user interface events generated by a remote-control device or other input device) and translates those inputs into the appropriate command for initiation by the foreign language tutor 100.

The acquisition engine 312 obtains language information for storage in data repository 316. More specifically, when a user specifies a language that is not the same as one of the languages of the audio tracks or subtitle tracks included with a particular program, the acquisition engine may interact with a remote source, such as the information provider 138 to obtain an audio or subtitle track in the specified language. In some embodiments, the acquisition engine 312 is capable of automatically translating a track in one language into a track in another language. For example, if a user specifies German for the subtitle track, but the program of interest only includes English and Spanish subtitle tracks, the acquisition engine 312 initiates machine translation of one or both of the English and Spanish subtitle tracks to generate a German subtitle track. In some embodiments, the translation is performed locally, whereas in other cases, translation services are provided remotely, such as by the information provider 138.

The data repository 315 stores program data corresponding to one or more programs. Typically, program data is received via communication system 108 from the program distributor 108 and includes video content, at least one audio track, and at least one subtitle track. The foreign language tutor 100 initiates presentation of the video content and subtitle track of a particular program by directing a video processing component (e.g., one of the other programs 330 and/or I/O devices 304) to present the video content and subtitle track on the display 302 or other presentation device. The foreign language tutor 100 also initiates presentation of an audio track for the program by directing an audio processing component (e.g., one of the other programs 330 and/or I/O devices 304) to produce audio output based on the audio track.

The data repository 316 stores language information. Language information includes reference information, such as dictionary definitions, thesaurus entries, word translations, etymologies, audio pronunciations, and the like. Language information may in some embodiments also include one or more audio or subtitle tracks organized into a library, such that audio or subtitle tracks in languages that are not part of received program content may be readily accessible to the foreign language tutor 100.

In some embodiments, the foreign language tutor 100 interacts with the program distributor 106, the content provider 104, and/or the information provider 138 for various purposes. As noted, the foreign language tutor 100 may request reference information, audio tracks, subtitle tracks, and the like from any one of sources 104, 106, or 138.

In an example embodiment, components/modules of the foreign language tutor 100 are implemented using standard programming techniques. For example, the foreign language tutor 100 may be implemented as a “native” executable running on the CPU 303, along with one or more static or dynamic libraries. In other embodiments, the foreign language tutor 100 may be implemented as instructions processed by a virtual machine that executes as one of the other programs 330. In general, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), declarative (e.g., SQL, Prolog, and the like).

The embodiments described above may also use well-known or proprietary synchronous or asynchronous client-server computing techniques. However, the various components may be implemented using more monolithic programming techniques as well, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously, and communicate using message passing techniques. Equivalent synchronous embodiments are also supported by a foreign language tutor implementation. Also, other functions could be implemented and/or performed by each component/module, and in different orders, and by different components/modules, yet still achieve the functions of the foreign language tutor.

In addition, programming interfaces to the data stored as part of the foreign language tutor 100, such as in the data repositories 315-316, can be available by standard mechanisms such as through C, C++, C#, and Java APIs; libraries for accessing files, databases, or other data repositories; through scripting languages such as XML; or through Web servers, FTP servers, or other types of servers providing access to stored data. The data repositories 315-316 may be implemented as one or more database systems, file systems, or any other technique for storing such information, or any combination of the above, including implementations using distributed computing techniques.

Different configurations and locations of programs and data are contemplated for use with techniques of described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, and the like). Other variations are possible. Also, other functionality could be provided by each component/module, or existing functionality could be distributed amongst the components/modules in different ways, yet still achieve the functions of a foreign language tutor.

Furthermore, in some embodiments, some or all of the components of the foreign language tutor 100 may be implemented or provided in other manners, such as at least partially in firmware and/or hardware, including, but not limited to one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), and the like. Some or all of the system components and/or data structures may also be stored as contents (e.g., as executable or other machine-readable software instructions or structured data) on a computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

The illustrated program distributor 106, content provider 104, and information provider 138 may be implemented using techniques similar to those described above. That is, each of the program distributor 106, content provider 104, and information provider 138 may comprise one or more computing systems similar to computing system 300, and include functionality implemented by way of a suitable arrangement of hardware, firmware, and/or software components.

D. Processes

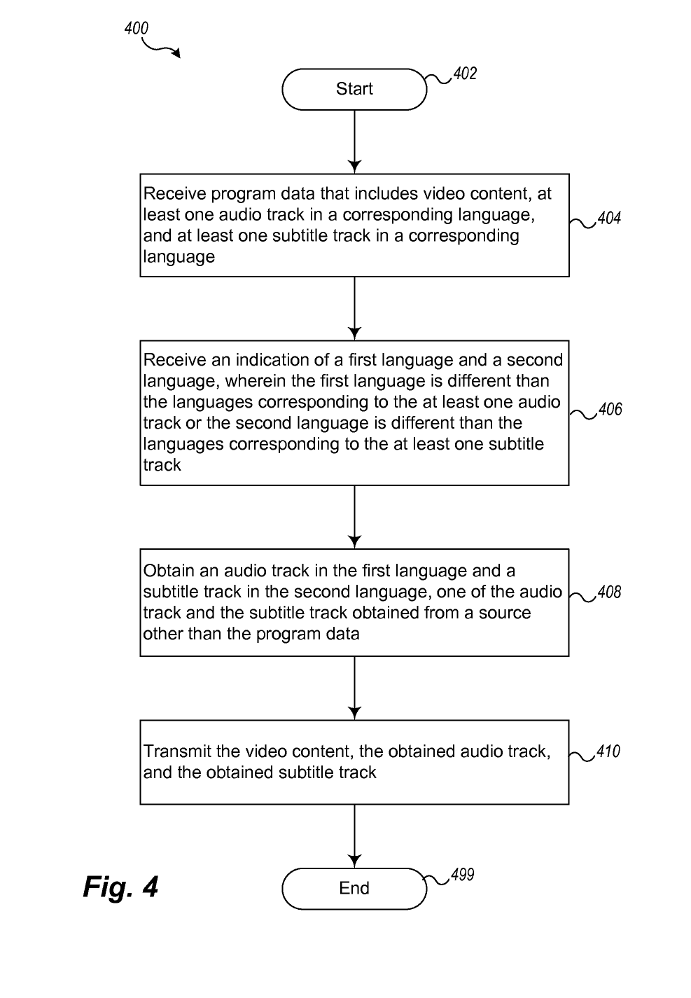

FIG. 4 is a flow diagram of an example foreign language tutor process provided by a first example embodiment. In particular, FIG. 4 illustrates process 400 that may be implemented by, for example, one or more modules/components of the foreign language tutor 100 executing on the receiving device 118, as described with respect to FIGS. 1A-1B and 3.

The illustrated process 400 starts at 402. At 404, the process receives program data that includes video content, at least one audio track in a corresponding language, and at least one subtitle track in a corresponding language. The process may receive the program data from a satellite network or other communication system.

At 406, the process receives an indication of a first language and a second language, wherein the first language is different than the languages corresponding to the at least one audio track or the second language is different than the languages corresponding to the at least one subtitle track. Typically, a user specifies the first language as the audio track language and the second language as the subtitle track language. Either one (or both) of the indicated first and second language are not part of the program data received at 404, above.

At 408, the process obtains an audio track in the first language and a subtitle track in the second language, one of the audio track and the subtitle track obtained from a source other than the program data. For example, if the program data does not include an audio track in the first language, then the process will obtain an audio track in the first language from a source other than the program data. Or, if the program data does not include a subtitle track in the second language, then the process will obtain a subtitle track in the second language from a source other than the program data. Sources other than the program data include local and remote sources, such as local libraries of subtitle/audio tracks, remote information providers, translation services, and the like.

At 410, the process transmits the video content, the obtained audio track, and the obtained subtitle track. Transmitting the video content, obtained audio track, and obtained subtitle track includes directing an audio/video processor to present, display or otherwise output video, text, and/or audio.

At 499, the process ends. In other embodiments, the process may instead continue to one of steps 404-410 in order to receive and process additional user inputs and/or present additional programs.

Some embodiments perform one or more operations/aspects in addition to the ones described with respect to process 400. For example, in one embodiment, process 400 also presents reference information for one or more words of the presented subtitle track.

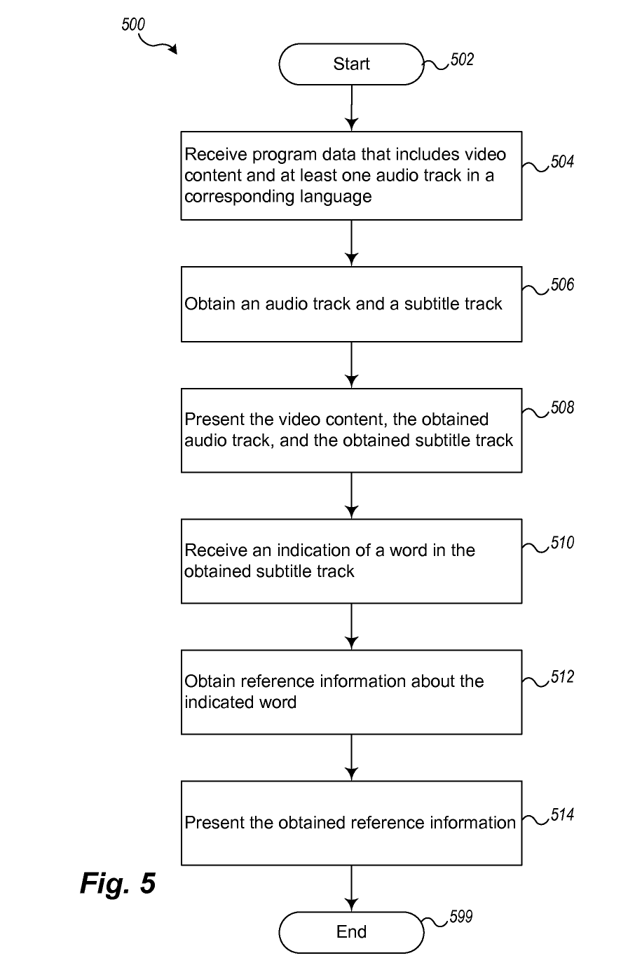

FIG. 5 is a flow diagram of an example foreign language tutor process provided by a second example embodiment. In particular, FIG. 5 illustrates process 500 that may be implemented by, for example, one or more modules/components of the foreign language tutor 100 executing on the receiving device 118, as described with respect to FIGS. 1A-1B and 3.

The illustrated process 500 starts at 502. At 504, the process receives program data that includes video content and at least one audio track in a corresponding language. The process may receive the program data from a satellite network or other communication system.

At 506, the process obtains an audio track and a subtitle track. Obtaining an audio or subtitle track may include reading a track that is part of the received program data. Obtaining an audio or subtitle track may further include receiving a track from a source other than the program data, such as a local data store, a remote information provider, a translation engine, or the like.

At 508, the process presents the video content, the obtained audio track, and the obtained subtitle track. Presenting the video content, obtained audio track, and obtained video track includes directing an audio/video processor to display or otherwise output video, text, and/or audio.

At 510, the process receives an indication of a word in the obtained subtitle track. Typically, a user indicates a word of interest in the subtitle track by operating a remote-control device.

At 512, the process obtains reference information about the indicated word. Obtaining reference information includes receiving a translation, dictionary definition, thesaurus entry, or the like, from a local or remote source.

At 514, the process presents the obtained reference information. Presenting the reference information includes directing an audio/video processor to display the reference information, as described with respect to FIG. 2C.

At 599, the process ends. In other embodiments, the process may instead continue to one of steps 504-514 in order to receive and process additional user inputs and/or present additional programs.

Some embodiments perform one or more operations/aspects in addition to the ones described with respect to process 500. For example, in one embodiment, process 500 facilitates payment to a third party information source for audio or subtitle tracks that are not part of the received program data.

While various embodiments have been described hereinabove, it is to be appreciated that various changes in form and detail may be made without departing from the spirit and scope of the invention(s) presently or hereafter claimed.

1. A set-top box configured to facilitate foreign language instruction, comprising:
an audio/video processor that is configured to:
receive program data comprising video content, at least one audio track in a corresponding language, and a plurality of subtitle tracks that are each in a corresponding language;
a language tutor module that is configured to:
receive from a user an indication of a first language and a second language, wherein the first language is different than the language corresponding to the at least one audio track or the second language is different than the languages corresponding to the plurality of subtitle tracks;
obtain an audio track in the first language and a subtitle track in the second language;
transmit to the user the video content, the obtained audio track in the first language, and the obtained subtitle track in the second language;
receive from the user an indication of a word in the obtained subtitle track; and
in response to the received indication of the word, transmit reference information about the indicated word to the user.

2. The set-top box of claim 1 wherein the first language is a native language of the user, and wherein the second language is not a native language of the user.

3. The set-top box of claim 1 wherein the first language is not a native language of the user, and wherein the second language is a native language of the user.

4. The set-top box of claim 1 wherein the language tutor module is configured to obtain the audio track or the subtitle track from a data store that is remote from the set-top box.

5. The set-top box of claim 1 wherein the language tutor module is configured to obtain the subtitle track by automatically translating one of the plurality of subtitle tracks into a subtitle track in the second language.

6. The set-top box of claim 1 wherein the reference information about the indicated word includes a dictionary definition of the indicated word and a thesaurus entry for the indicated word.

7. A method in a receiving device for facilitating foreign language instruction, the method comprising:
receiving program data that includes video content, at least one audio track in a corresponding language, and at least one subtitle track in a corresponding language;
receiving an indication of a first language and a second language, wherein the first language is different than the languages corresponding to the at least one audio track or the second language is different than the languages corresponding to the at least one subtitle track;
obtaining an audio track in the first language and a subtitle track in the second language, one of the audio track and the subtitle track obtained from a source other than the program data; and
transmitting the video content, the obtained audio track, and the obtained subtitle track.

8. The method of claim 7 wherein the receiving device is a set-top box communicatively coupled to a satellite network and to a display device, wherein receiving the program data includes receiving the program data from a satellite network, and wherein transmitting the video content includes presenting the video content upon the display device.

9. The method of claim 7 wherein the receiving device is located at a customer premises, and wherein obtaining the subtitle track includes receiving the subtitle track from an information source that is remote from the customer premises.

10. The method of claim 7 wherein obtaining the subtitle track includes receiving the subtitle track from a data store local to the receiving device.

11. The method of claim 7 wherein obtaining the subtitle track includes initiating a payment to a remote information source in exchange for the obtained subtitle track.

12. The method of claim 7 wherein obtaining the audio track includes obtaining the audio track from an information source that is remote from the receiving device.

13. The method of claim 7, further comprising:
receiving an indication of a word in the obtained subtitle track;
obtaining reference information about the indicated word; and
transmitting the obtained reference information along with the video content.

14. A computer-readable storage medium whose contents enable a receiving device to facilitate foreign language instruction, by performing a method comprising:
receiving program data that includes video content and at least one audio track in a corresponding language;
obtaining an audio track and a subtitle track;
presenting the video content, the obtained audio track, and the obtained subtitle track; and
during presentation of the video content,
receiving an indication of a word in the obtained subtitle track;
obtaining reference information about the indicated word; and
presenting the obtained reference information.

15. The computer-readable storage medium of claim 14 wherein receiving the program data includes receiving the program data from a satellite broadcast network, and wherein obtaining the reference information includes receiving the information from an Internet Protocol network.

16. The computer-readable storage medium of claim 14 wherein the obtained audio track is not one of the at least one audio tracks, and wherein obtaining the audio track includes receiving the audio track from a source that is remote from the receiving device.

17. The computer-readable storage medium of claim 14 wherein obtaining the reference information includes obtaining a dictionary definition of the indicated word from an information source that is remote from the receiving device.

18. The computer-readable storage medium of claim 14 wherein obtaining the reference information includes obtaining a dictionary definition of the indicated word from a data store that is local to the receiving device.

19. The computer-readable storage medium of claim 14 wherein the indicated word is in a language that is not native to a viewer of the video content, and wherein obtaining the reference information includes obtaining reference information in a language that is native to the viewer.

20. The computer-readable storage medium of claim 14 wherein the program data includes at least one subtitle track in a corresponding language, and wherein obtaining the subtitle track includes obtaining the at least one subtitle track from the program data.

21. The computer-readable storage medium of claim 14 wherein the program data includes at least one subtitle track in a corresponding language, and wherein obtaining the subtitle track includes receiving the obtained subtitle track from a source other than the program data.
